(19) United States
(12) Patent Application Publication
(10) Pub. No.: US 2008/0220399 A1
(43) Pub. Date: Sep. 11, 2008

(54) Cognitive educational tool for effectuating learning

(76) Inventor: Christopher Kayode Giwa, Toledo, OH (US)

Correspondence Address: CHRISTOPHER GIWA, 2331 ROCKSPRING ROAD, TOLEDO, OH, 43614, US

(21) Appl. No.: 12/072,873

(22) Filed: Feb. 29, 2008

Related U.S. Application Data
(60) Provisional application No. 60/892,769, filed on Mar. 2, 2007.

(51) Int. Cl. G09B 19/22

(52) U.S. Cl. 434/129

(57) ABSTRACT

The following concept is to be utilized in the acquisition of information by combining various learning styles. Key areas addressed are the increment of student participation, increased levels of student honesty, and higher rates of student responsivity. The tool encourages the development of student-teacher rapport levels and thus promotes the ability to acquire and retain functional techniques and information. The concept addresses real life situations by creating functional problem solving strategies to be used at specific junctures in both the scenarios and everyday life. The tool is preventative in nature, and is also culturally, cognitively, age appropriate, gender and scenario flexible. The adaptability highlights the vast spectrum of issues the concept can resolve. Overall the process is designed to increase participants' level of competency when encountering situations, which impact their pro social development and/or success in real life situations. In doing so the likelihood of engaging in detrimental or negative behaviors is significantly reduced. The program focuses on enhancing social skills, responsibility, self-control, pro social cognition, and moral reasoning. All of the aforementioned skills are nurtured and developed through the alternative learning style used to engage the client, through the therapeutic process.

Priority is claimed from: this present non-provisional application claims priority based on the provisional application, 60/892,769 filed on Mar. 2, 2007. The subject matter is incorporated in the application herein.

An educational conceptual framework in the form of a game, which incorporates movement or interaction for the participants as a key part of the learning process through two phases.

The said learning process involves a given ‘scenario card’ which describes a situation from any venue of life. The participants read the initial ‘scenario card’ and on a turn basis select a ‘movement card’ which help said participants move from ‘station card’ to ‘station card’. This is known as phase one of the exercise. Each ‘station card’ has a number of ‘movement cards’ directing the movement of said participants. Each participant retains every ‘movement card’ selected. In phase two there are ‘critical thinking cards’ which correspond specifically to a particular ‘movement card’ utilized in phase one.

The instructor/teacher/counselor/generates analytical discussion of decisions made with the aid of the ‘critical thinking cards’, again completed on a turn basis with each participant. When this is completed the exercise is finished.

The said educational conceptual framework as described is in the form of laminated cards; said ‘station cards’ measure 9″×12″, said ‘movement cards’ and said ‘critical thinking cards’ measure 3″×4″. The level of movement is the key attribute, particularly with younger participants. The use of props by the said ‘station cards’ is essential since it aids the user by way of a visual reminder.

The level of language used to describe said ‘scenario cards’, ‘movement cards’, and ‘critical thinking cards’ can vary depending on the targeted participants.

The said educational conceptual framework can be used in other formats, such as but not limited to computer software, video and DVD, and Blue-Ray technology. Utilizing these formats allows for interactive learning. The software will also provide the ability to capture the forward and backward movement detailed in the laminated card version.

The laminated card version of said educational conceptual framework will have various props at the said ‘station cards’. The purpose is to increase the level of visual stimulation particularly in scenarios designed for younger participants. The use of visual aids will increase the level of ability to recollect information of said participants, especially when engaged in real life situations.

### FIELD OF THE INVENTION

Priority is claimed from: this present non-provisional application claims priority based on the provisional application, 60/892,769 filed on Mar. 2, 2007. The subject matter is incorporated in the application herein.

The present invention relates to educational games, and more specifically pertains to a new educational conceptual framework model for identifying negative outcomes in any given decision making process. The said educational conceptual framework model can be used in areas such as, but not limited to scenario setting, teaching, counseling, training and so on.

Generally the said educational conceptual framework model is an invention with the premise of overcoming and surpassing the shortcomings of existing educational games. Most importantly the introduction of movement and the incorporation of visual aids will significantly increase the user's ability to retain information. With the increased information retention, the said educational conceptual framework model is preventive in nature in that it will allow participants to avoid harmful outcomes in real life scenarios with repeated practices of said material. Utilization of the said practice will increase the users' comprehension of any given situation in areas such as, but not limited to everyday life, workplace, school and so on.

It will be appreciated that the scope of the present invention is not limited to the above-described embodiments but rather is defined by the appended claims, and that these claims will encompass modifications of and improvements to what has been described.

In education, various advantages of using private teachers to give individual attention to accommodate each student's skill, educational goals and background are well known. Students can excel and improve immensely tests/assessments of the student's skill, educational goals and background in designing individualized curriculum make the private teacher approach too expensive for most students.

Many conventional educational systems attempt to personalize learning sessions for students and avoid the cost of employing private tutors by using computer programs in place of actual teachers. However, these systems have gone too far in automating educational processes and consequently have been shown to be too automated and lacking the necessary involvement by actual teachers to make the systems effective.

### BACKGROUND OF THE INVENTION

Many school systems have become highly centralized. Large schools have evolved, which serve wide geographic areas. The geographic area covered by some schools is so wide that certain students must make a round trip of one hundred miles, or more, to attend classes.

One benefit of a large, centralized school is that a vast, diverse curriculum can be offered. It is desirable to offer the diverse curriculum, without imposing the long-distance

b) Description of Related Art

People tend to differ widely in how they best receive and process information. For example, if a group of people are learning about ceramics in a classroom setting, one individual may best understand and process the information by listening to the instructor lecture. Another student may prefer to read the textbook, while still another may understand and retain the most information when they see photographs or diagrams illustrating the concepts. Others still may prefer an early morning class to an afternoon or evening class, or prefer studying in a large comfortable chair in a brightly lit room while listening to classical music.

The extent to which an individual receives sensory information in a format and setting that is compatible with how they best process information goes a long way towards determining how well that person learns. Formats and settings that deviate somewhat from a person's ideal can degrade that person's ability to learn. Formats and/or settings that deviate significantly from a person's ideal can actually prevent the person from learning. This situation can be seen in many schools where some children fail to learn, not because they do not have the intelligence to understand and process the lessons, but because the instruction is presented in a format and/or setting that deviates significantly from the particular child's ideal.

### Linearity

A considerable amount of research has been devoted to identifying a person's “learning style”, i.e., the various formats, environmental settings and other variables that are most compatible with how that person best understands and processes sensory information. So-called “learning style models” have been developed in which specific and varied information is gathered from an individual and used to extrapolate that person's learning style. The information may be gathered through direct observation of the person, paper and pen questionnaires, pencil-based answer sheets of the type that can be scanned into a computer scoring system, or computer assisted questionnaires in which the user answers the various test questions as they are presented on the computer screen. The questionnaires generally include a range of possible answers such as always, usually, sometimes, rarely and never.

The questionnaire answers are then analyzed, either manually or by computer, to produce a learning style profile. The learning style profile is then analyzed, again either manually or by computer, to produce a learning style report. Under the manual analysis technique, an individual specifically trained in the particular learning style model must interpret the profile in order to generate a report. Under a computer analysis technique, the profile data must be re-entered in order to produce the report. In either case, the learning style report identifies individual learning factors and may include suggestions for learning enhancements.

The above-described learning style model questionnaires can be extremely tedious for the person taking the test. In particular, they are typically lengthy and require good silent reading and comprehension skills and a long attention span in order to render relevant information. The options for administering any given questionnaire, or for analyzing questionnaire results, are generally limited and not very flexible. Accordingly, there is a need for a more flexible and user-friendly method of administering learning style model questionnaires and analyzing the results thereof.

It is widely acknowledged that education is truly a key to many facets of life. In fact, education is and historically has been, in the United States and many countries, a leading public policy priority. Therefore, improvements in the ability to provide learning, from the standpoint of meaningful success for the students, as well as efficient allocation of resources towards that end, should be a primary goal of all levels of government and its citizens. Studies have shown that one root of illiteracy is lack of foundational learning and training by the first grade level. A need therefore exists regarding efficient and effective training of pre-reading skills for first graders and even kindergartners. The ability of children this age to self-teach is minimal. Therefore, an effective automated learning assistance system would be of tremendous value to children, as well as society in general, if viewed from a long-term perspective.

### DETAILED DESCRIPTION OF THE PREFERRED EMBODIMENTS

The description of the invention which follows, together with the accompanying figures should definitely not be construed as limiting the concept to the example shown and described. The scope of the said educational conceptual framework is infinite, and countless scenarios will be devised within the ambit of the appended claims.

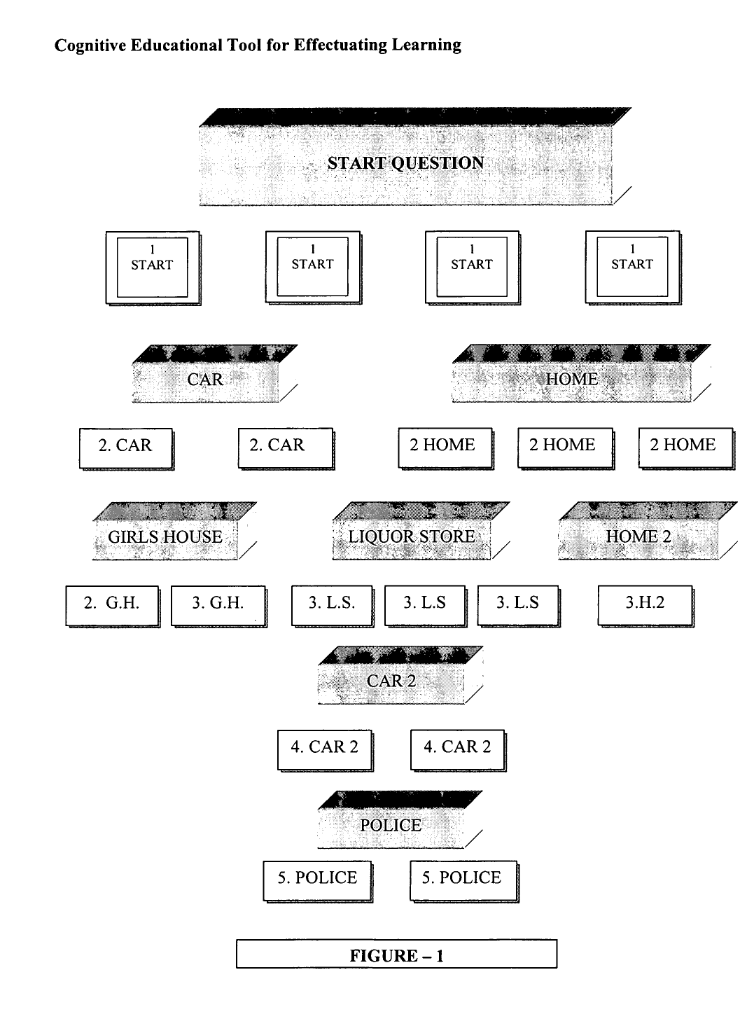

FIG. 1 is a front elevational view of the said educational conceptual framework, and specifically how it is laid out. This particular example is in the laminated card version. This should not be construed as the only version of the concept.

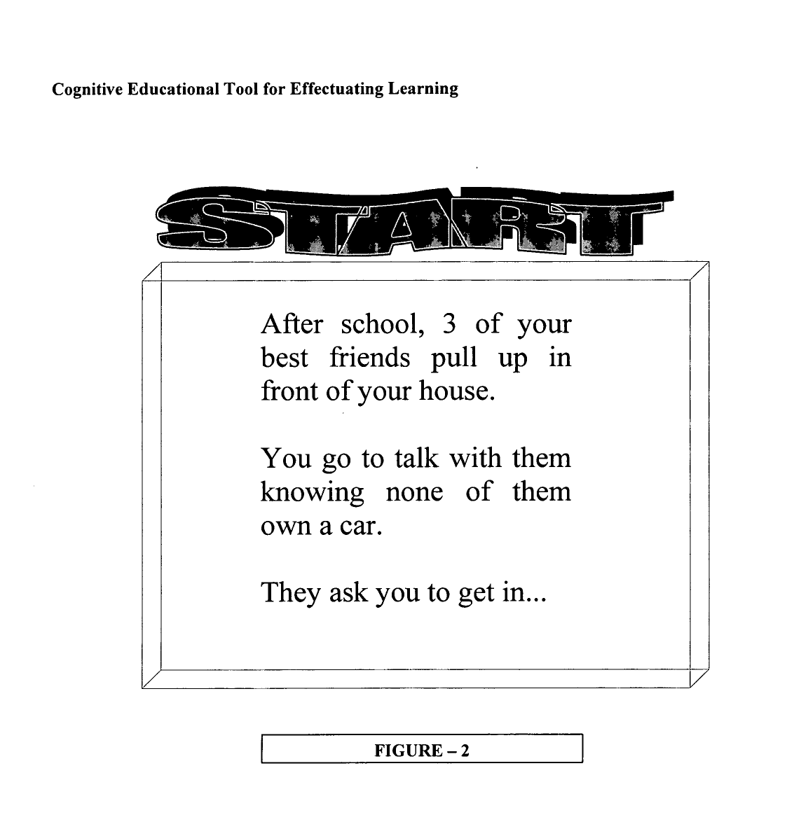

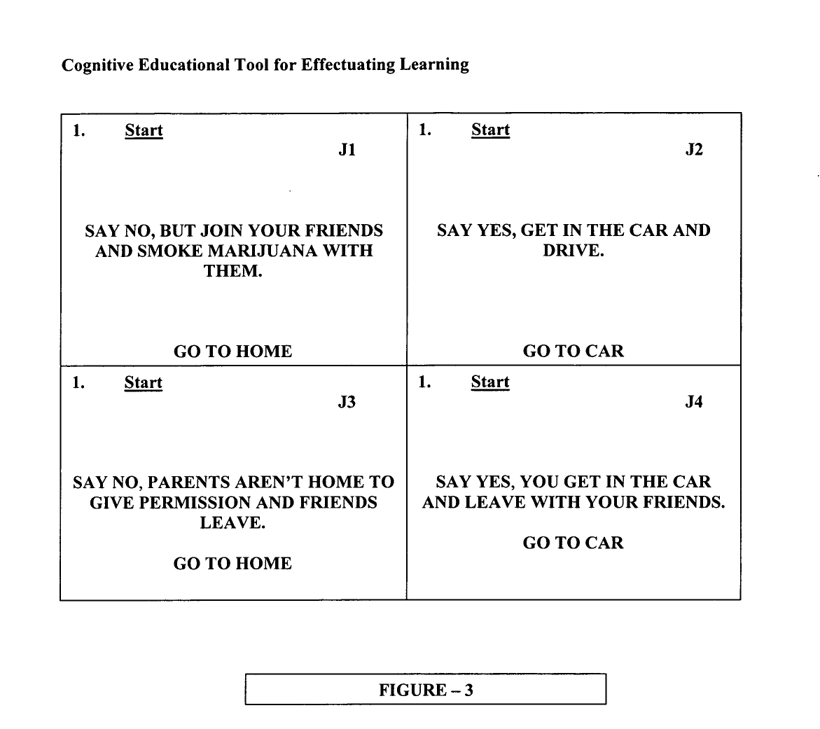

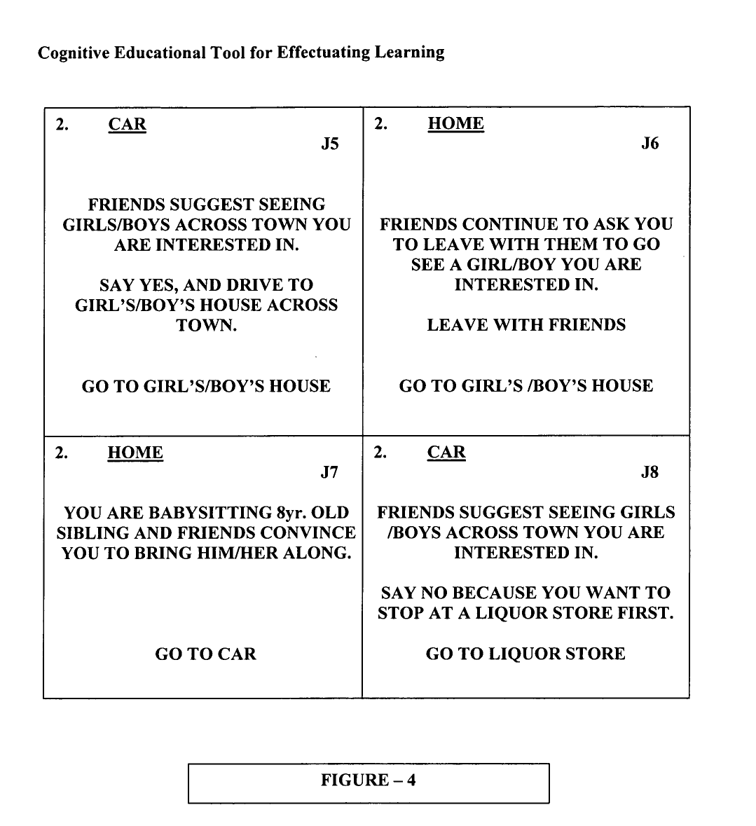

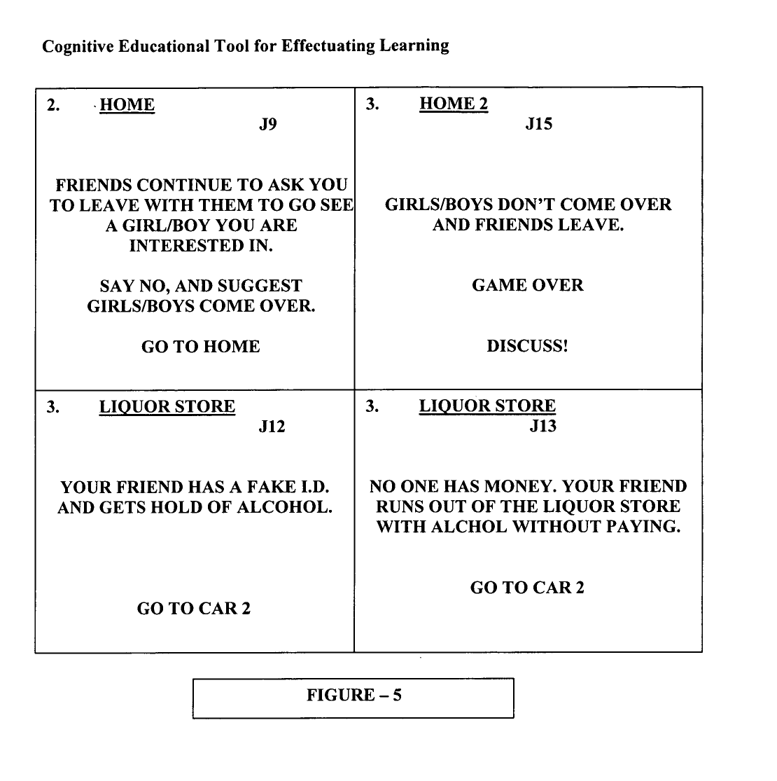

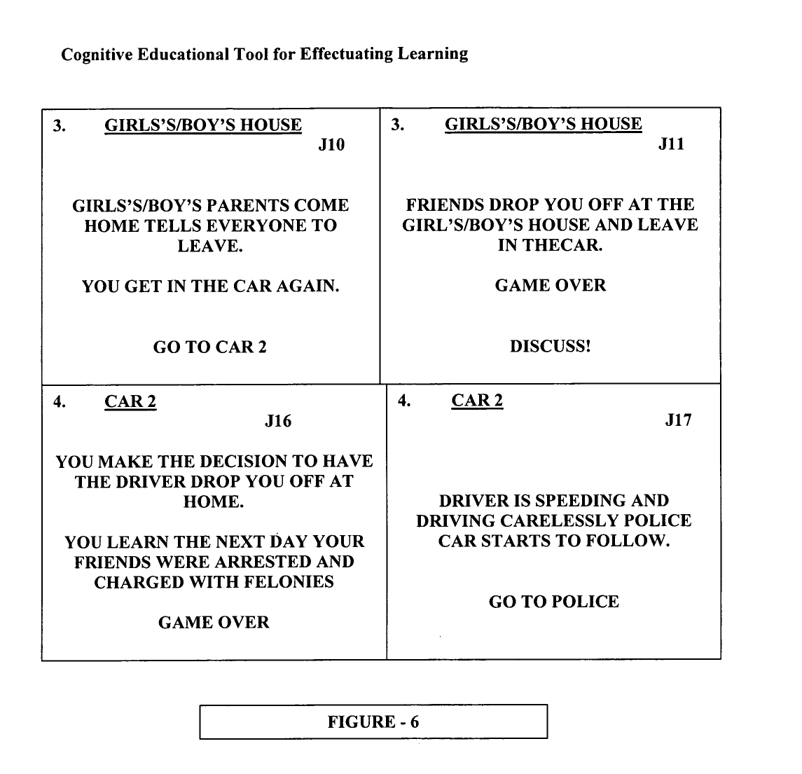

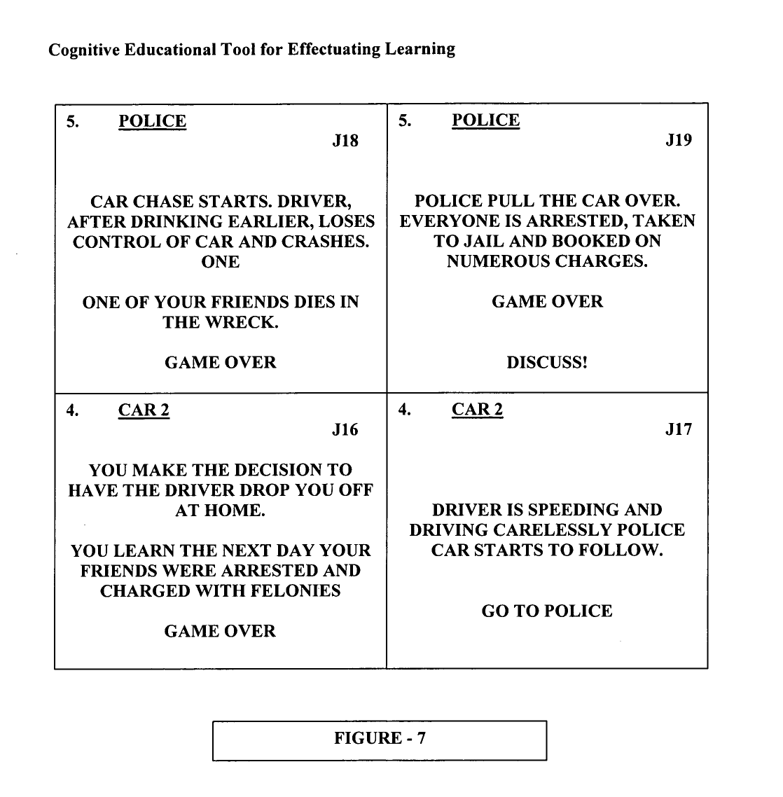

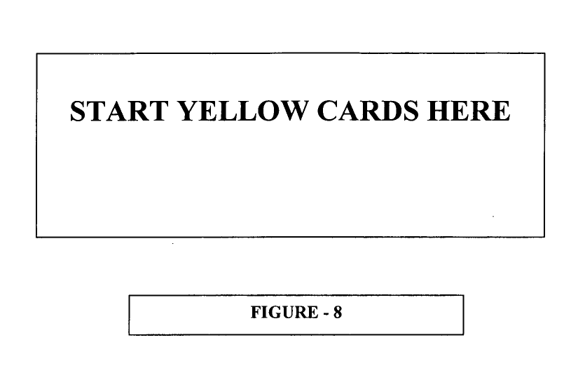

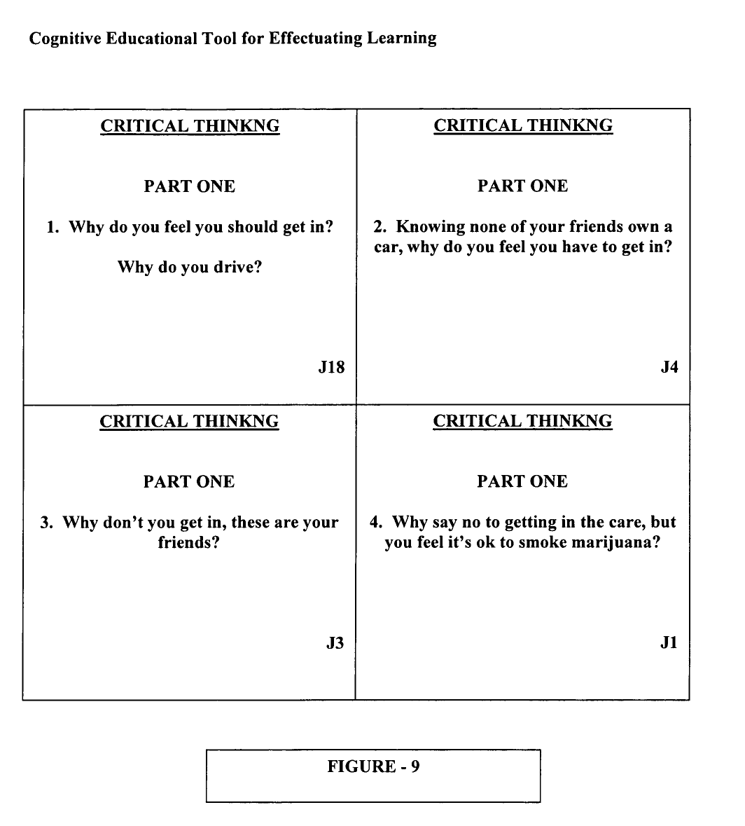

FIG. 2 is a perspective view of the said educational conceptual framework's ‘movement cards’. This example is part of the laminated card version. This should not be construed as the only version of the concept.

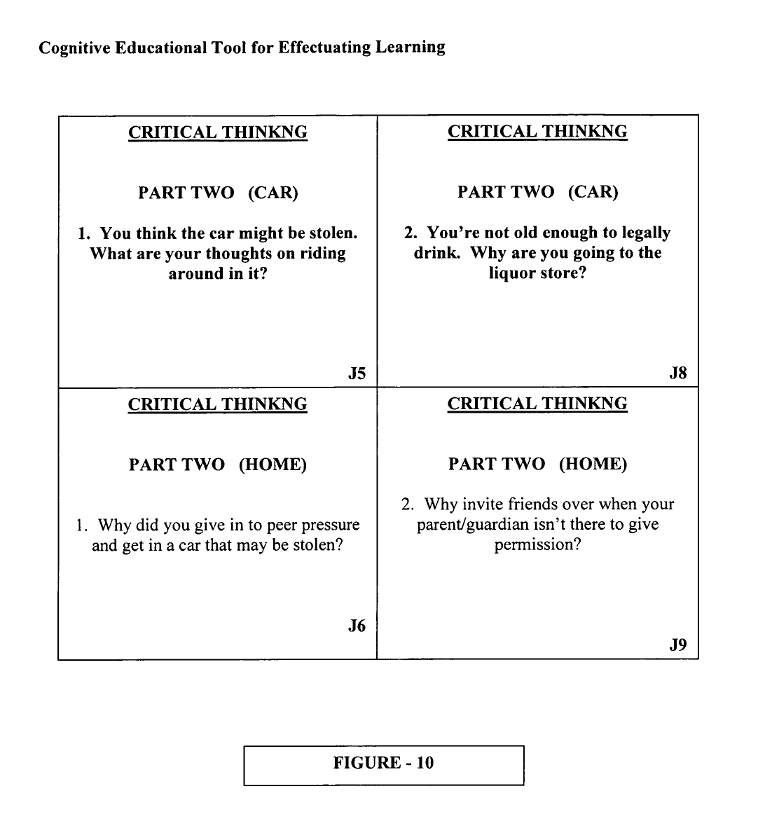

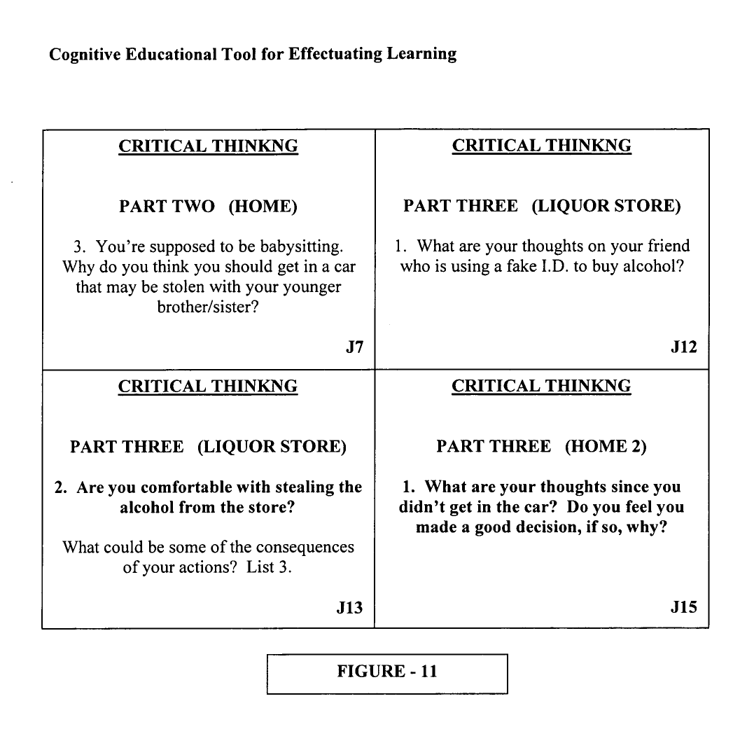

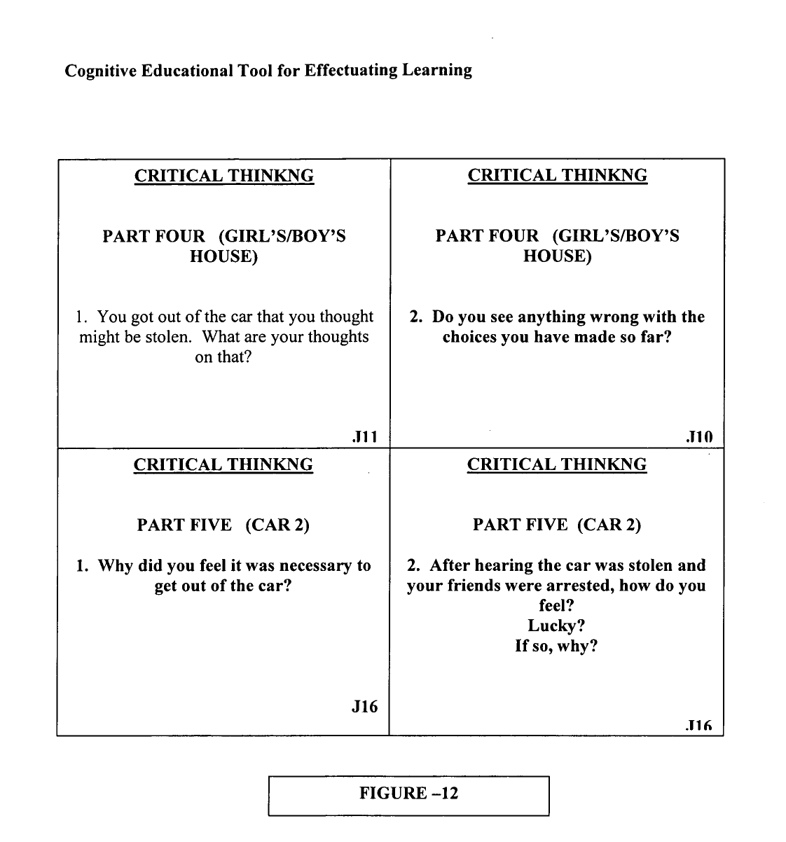

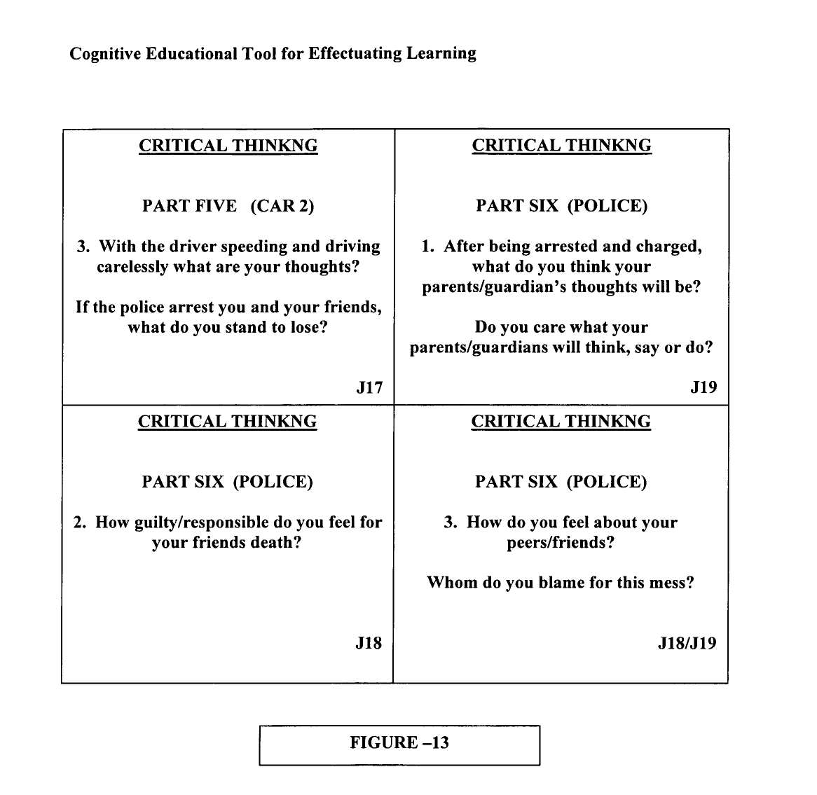

FIG. 3 is a perspective view of the said educational conceptual framework's ‘critical thinking cards’. This example is part of the laminated card version. This should not be construed as the only version of the concept.

With reference now to the illustrations, and specifically FIG. 1 to FIG. 3 thereof, a new educational conceptual framework for learning and practicing steps in any given decision making process, thus highlighting possible problem areas will now be described.

FIG. 1 provides a front elevational view of how the concept is set up. The cards are all placed on the floor in a room that will allow for maximum movement, i.e., a classroom/training room. In this particular example, there are 8 ‘station cards’—labeled ‘A’ through ‘H’. There are also 19 ‘movement cards’—labeled ‘J1’ through ‘J19’.

In FIG. 1, (A) represents the starting point of the scenario and the particular topic being taught/practiced. On card 1(A) is a given situation, which either the instructor(s) or participants read out aloud. Below the Start ‘station card’ are four ‘movement cards’—labeled ‘J1’ through ‘J4’, (note all the ‘movement cards’ are placed on the floor face down, the reason being participants believe selecting ‘movement cards’ at random injects an element of choice into the game). On a turn basis the participants select 1 ‘movement card’. Each participant reads the information on the card aloud, and before moving onto the next ‘station card’ retains the selected ‘movement card’ on their person. The ‘movement cards’ should be kept in the order they were selected. ‘Movement cards’ ‘J1’ through J4’ contains a specific ‘decision’ which the participant has to follow. At the bottom right-hand corners of the ‘movement cards’ are instructions, which direct the participants to the next ‘station card’.

Participants progress through the exercise selecting ‘movement cards’ and moving from ‘station card’ to ‘station card’. The level of writing on the ‘movement cards’ can vary depending on the grade level/age/comprehension of the participants. The movement from ‘station card’ to ‘station card’ can vary depending on the participant's age group. For example younger children can jump, hop, or skip from ‘station card’ to ‘station card’, hence the need for a large room. The purpose behind such a technique is to infuse enjoyment into the learning process, and to distance participants from the traditional textbook learning process. In doing this the ability to retain newly acquired information is greatly increased.

Participants proceed through the given scenario by way of the ‘movement cards’. Phase one of the exercises is completed when the ‘movement cards’ indicate so. When the first phase of the exercise has been completed Phase two, begins. Phase two is depicted in FIG. 3 with the use of the ‘critical thinking cards’. The premise of Phase two is to elicit discussion through the analysis of the ‘decisions’ each participant has made. Remembering both participants have retained the ‘movement cards’ from Phase one of the exercise is essential to Phase two. The instructor/counselor utilizes the ‘critical thinking cards’ to generate analytical discussion about the scenario in question. Each ‘movement card’ that the participants retain has a corresponding ‘critical thinking card’ the instructor uses the ‘critical thinking card’, (that corresponds to said ‘movement card’), to ascertain as to why a certain ‘decision’ was made. In turn the participant is expected to explain why they ‘made’ a certain decision in the scenario. This practice encourages the participants to place themselves in the scenario and analytically think of responses. The cognitive process that occurs will allow for a person to not only create ‘forced responses’ but also shows how they will think, should they ever face the scenario in a real life situation. The instructor analyzes each participants ‘movement card’ on a turn basis.

Upon review this educational conceptual framework has a unique approach to the learning/practicing of infinite scenarios. As opposed to textbook learning, the said educational conceptual framework allows for a multi-systemic approach to retaining information. Phase one of the exercise draws in the participants by the use of movement, tactile, and visual techniques. Abstract thought and the ability to analyze ‘poor decisions’ ahead of time allows for the safe immersion in negative and positive human experiences, and illustrates how poor choices can escalate into tragic outcomes. Repeated practices of any given scenario in the educational conceptual framework will undoubtedly increase the participants' ability to avoid pitfalls in real life situations. The advantages and scope of the said educational conceptual framework herein are not to be limited to, or defined by the example listed. The example can be applied to an inordinate amount of scenarios, involving numerous participants. The version denoted in the example of the educational conceptual framework can be presented to users in a variety of other formats, including, but not limited to interactive computer software, interactive video, interactive DVD, and interactive Blue-Ray, and so on.

I claim:

1. a cognitive educational tool for effectuating learning for any group of individuals comprising:
a) a set of instructions depicting the setup the setup of the cognitive educational tool with sets of movement-choice cards and station cards, each consisting of a front and back surface, with said front surface having printed material representations depicting either directions of locations in the exercise respectively.
b) the ability of participants to randomly select movement cards on a turn by turn basis from the aforementioned set of movement cards, educational tool for effectuating learning which in turn directs individuals by way of a choice made to a specific station card which prompts the participant in the movement phase of the cognitive educational tool for effectuating learning.
the cognitive educational tool for effectuating learning proceeds into the critical analysis phase which requires completion of the movement phase determined by instructions/choices on the movement-choice cards of claim 1, and participants retaining movement/choice cards they have selected; meanwhile the instructor in turn has a set of critical analysis cards, each of which correspond to the movement-choice cards of claim 1 and are used to analyze the participants movement-choice cards randomly selected during the first phase of the exercise.
the critical analysis cards of claim 2 are possessed only by the instructor, and each movement-choice card has one or more corresponding critical thinking cards, which are used to analyze choices/thinking errors, and responses that were randomly selected by the participants.
the critical analysis phase of the cognitive educational tool for effectuating learning embodies the bulk of the learning experience wherein decisions made by participants through the movement phase of claim 1b are critically analyzed on a participant turn-by-turn basis through the instructor's utilization of the critical thinking cards; additionally the ability to utilize or apply multiple critical thinking cards to a specific movement-choice card is done so at the instructors' discretion in order to challenge, critique, change and therapeutically address choices of a positive or negative nature.
the cognitive educational tool for effectuating learning is completed when the instructor has firstly completed both the movement and critical analysis phases, and also when participants and instructors alike have engaged in the critical analysis' therapeutic and counseling stage, and the decisions of individuals are challenged using the experiences from the cognitive educational tool, and real life scenarios; bearing in mind the central premise of the cognitive tool is to rehearse everyday situations that may occur in real life.
the cognitive educational tool for effectuating learning utilizes the movement-choice cards, and station cards of claim 1b, the latter of which takes the form of different styles such as but not limited to a card, or a like visual aid or prop which enhances the ability to retain participant information due to the visual context of said station depiction.
the cognitive educational tool for effectuating learning uses setup instructions of claim 1a, which take the form of written instructions and the need for a conference/training room or use of the laminated sheet included with said tool to setup exercise, furthermore the need to use the aforementioned laminated sheet only applies to this particular example since other styles to setup the cognitive educational tool in different formats exist.
Within the ambit of the movement phase participants are having attitudes, values, beliefs, deductive reasoning skills, morals, and problem solving skills analyzed through a multitude of counseling techniques and theories such as but not limited to, reality therapy, solution focused therapy, brief therapy, strategic theory, cognitive behavioral therapy, (rational versus irrational, cognition, feelings and behavior, responsible thinking process), structural family therapy, system theory, and relapse prevention.
During the critical analysis phase the participants along with the instructor's guidance, (and use of the critical thinking cards), critically analyze decisions/choices made during the movement phase which will allow for gains such as but not limited to; the ability to identify key points in a series of events, the ability to use better judgment in any given scenario, the ability to hold oneself accountable for certain decisions which can and will occur during not only given scenarios but also in real life, social skills training and development, self awareness development, and competency development are typically achieved within the scope of the psycho educational curriculum under the ambit of the cognitive educational framework tool for effectuating learning.
Within the ambit of the cognitive educational framework tool is the instruction process which utilizes research based step by step materials/information for people such as but not limited to exercise participants, new clinicians and counselors, seasoned/experienced professionals, students, interns, parents and so on.
The uses and advantages of the cognitive educational framework tool are countless, and can be illustrated in various forms such as but not limited to, the ability for an inexperienced exercise facilitator to engage and build a good rapport/environment for learning, (can transcend barriers such as race, color, culture, gender, age and so on), the ability to not train staff in specific areas due to the research based information as in claim 5, the utilization of visual aids and props to enhance the memorization of techniques learned, the ability to use differing levels of language depending on the culture, cognitive level, comprehension level, and socio economic level, and so on.
The utilization of educational concepts and practical application hence forth can lead to sensory and cognitive integration for a variety of target populations such as but not limited to, at risk youths, prevention for elementary, grade school and junior/high school children, juvenile delinquents, cognitive delayed, emotionally delayed, learning disabled, children, adolescents, adults and so on.
The third area of the cognitive educational framework tool for effectuating learning focuses on the various types of multi media formats for practical application such as but not limited to computer software, board games, (condensed to a reduced movement application specifically for participants who have space or mobility restrictions), internet distance learning, video conferencing, online forums, visual aids, PowerPoint, DVD's Blue Ray discs, and compact discs; all of which increase the amount of prospective users.
the embodiments of the claims depict the utilization of the aforementioned tool in only one current form, this should not be construed as the only format the tool is to be used in.
